(19) United States
(12) Patent Application Publication
(10) Pub. No.: US 2007/0159555 A1
(43) Pub. Date: Jul. 12, 2007

(54) Video displaying device

(75) Inventors: Shu-Yi Chen, Taipei (TW); Chang-Hung Lee, Tou Nan Chen (TW)

Correspondence Address: LADAS & PARRY, 26 WEST 61ST STREET, NEW YORK, NY, 10023, US

(73) Assignee: BENQ CORPORATION

(21) Appl. No.: 11/651,629

(22) Filed: Jan. 9, 2007

(30) Foreign Application Priority Data
Jan. 12, 2006 (TW) 95101255

(51) Int. Cl. H04N 7/20; H04N 7/00

(52) U.S. Cl. 348/552; 725/72

(57) ABSTRACT

A video displaying device connected to a first display comprises a connecting port, a second display, a signal processing unit, a microcontroller, and a switching unit. The connecting port is used for connecting to the first display, the signal processing unit is used for generating a first video signal, the microcontroller is used for generating a control signal and transmitting the control signal to the signal processing unit for generating a second video signal, and the switching unit is used for triggering the signal processing unit to selectively transmit the first video signal and the second video signal to the connecting port and the second display.

### FIELD OF THE INVENTION

The present invention relates to a video displaying device, and more particularly to a video displaying device provided with a display for displaying video display signal and setting signal thereof.

### BACKGROUND OF THE INVENTION

A living room is a place for all family members doing mutual activities and enjoying entertainments. While watching television programs, listening multimedia CDs, and singing karaoke are the most preferred entertainments of all, so televisions are the most important entertainment devices in our daily life already. Furthermore, accompanying with the development of digitalization and Internet, the television system will be the center of a family in the future as well. Except for televisions, projectors are gradually becoming a main stream for family entertainment, and there are still many kinds of the video displaying devices being provided as usual, such as DVD (Digital Versatile Disk) Recorders, Video Set-up-Boxes, and DMA (Digital Media Adapters), etc.

Most of the video playing devices as mentioned above are provided with optional playing functions for users' operations in order to play and save data according to the users' favorites. Please refer to FIG. 1, which is a front elevation presenting a video playing device being provided in prior arts. As shown in the FIG. 1, a video displaying device 10, herein is a DVD recorder, is connected to a display 11, herein is a television, the video displaying device 10 can transmit a video signal to the display 11 and then display the video signal. The video displaying device 10 includes a display screen 101, such as a VFD (vacuum fluorescent display) or a FPD (Flat Panel Display), which is to be an interface for displaying the working statuses of the video displaying device, such as video display, title of video, playing time, etc.

With the development of information system and Internet, the video displaying device 10 tends to provide additional multiple functions, i.e., the DVD Recorder can connect to the Internet, and the Video Set-up-Box also has the functions of saving and displaying video data. However, the display screen 101 used for displaying the working statuses of the video display is too simple with respect to the multiple functions to display the working statues in detail.

The current video displaying device 10 shall firstly turn on the external-connected display 11 to display OSD (On-Screen Display) when executing all related setup, such as the pre-recoding function of the DVD Recorder, then inputting the information of recording video, playing video, etc. by means of a remote controller. Such complicated operation processes as mentioned above have brought many inconveniences to the users.

Besides, the setting frames provided with a plurality of control commands must overlap the video frame to influence the user watching video programs when selecting and executing at least one of the control commands under the status that the video displaying device is displaying video.

Thus, the invention discloses a video displaying device to replace an original display used for simply displaying working statuses. That is, the display of the present invention is used for progressively displaying video and controlling commands.

### SUMMARY OF THE INVENTION

The primary object of the invention provides a video displaying device with a display used for displaying a video signal and a control signal in order to improve the convenience of users' operation.

Another object of the invention provides the video displaying device with a display used for displaying a video signal and a control signal in order to display the working statuses of the video displaying device in detail.

In the present invention, the video displaying device connected to a first display comprises a connecting port, a second display, a signal processing unit, a microcontroller, and a switching unit. The connecting port is used for connecting to the first display, the signal processing unit is used for generating a first video signal, the microcontroller is used for generating a control signal and transmitting the control signal to the signal processing unit for generating a second video signal, and the switching unit is used for triggering the signal processing unit to selectively transmit the first video signal and the second video signal to the connecting port and the second display.

The video displaying device further includes a multiplexer connected to the connecting port and the second display. The multiplexer is used for receiving the first video signal and the second video signal. The switching unit controls the multiplexer to selectively output in a first mode, a second mode and a third mode. In the first mode, the multiplexer outputs the first video signal to the connecting port and the second display; in the second mode, the multiplexer outputs the first video signal and the second video signal to the connecting port and the second display respectively; and in the third mode, the multiplexer outputs the first video signal and the second video signal to the second display and the connecting port respectively.

In the present invention, a method is disclosed for setting a video displaying device provided with a signal processing unit for outputting at least one video signal to accordingly display at least one video on a first display and a second display, and includes the steps of: (a) outputting a control signal to the signal processing unit; (b) displaying a plurality of control commands corresponded to the control signal on the second display, and keeping the first display normally outputting; and (c) selecting and executing at least one of the control commands, and interrupting displaying the control commands on the second display.

The video displaying device further includes a microcontroller for generating the control signal, and a hot key for triggering the microcontroller to output the control signal to the signal processing unit, therefore the signal processing unit keeps that the first display normally outputs the video signal, and the hot key interrupts the video signal being normally outputted.

According to above description, the video displaying device is provided with the second display for displaying the video signals and the control signals, so that the user can execute setting functions of the video displaying device even under a situation that the first display is turned off. Additionally, the switching unit is provided for controlling the output of the video signal toward the second display. Besides, the hot key is further provided in accordance with the present invention, so that the user can engage in the setting functions of the second display without interrupting the first display so as to improve the convenience to the users. Additionally, the second display shows the complete information to let users know the working status.

The devices, characteristics and the preferred embodiment of this invention are described with relative figures as follows.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front elevation of a video displaying device provided in prior arts;

FIG. 2 is a system diagram of a video displaying device provided in accordance with a preferred embodiment of the present invention;

FIG. 3 is a front elevation of the video displaying device provided in accordance with the preferred embodiment of the present invention;

FIG. 4 is a diagram presenting a mode switching sequence in accordance with the preferred embodiment of the present invention; and

FIG. 5 is a flowchart presenting the steps of a method for setting the video displaying device as disclosed in the present invention.

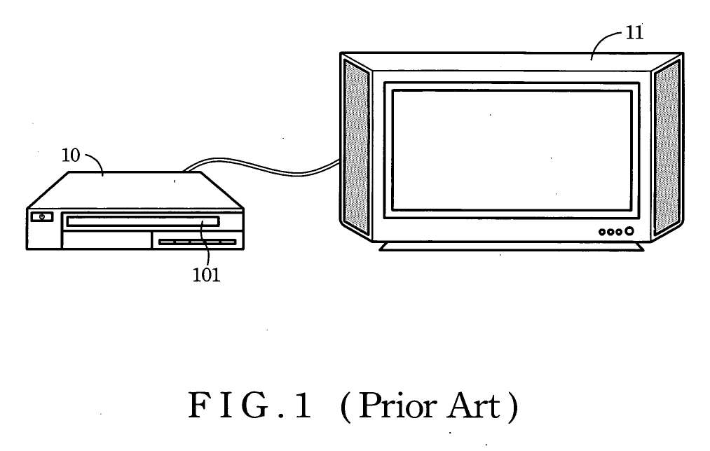

### DETAILED DESCRIPTION OF THE PREFERRED EMBODIMENTS

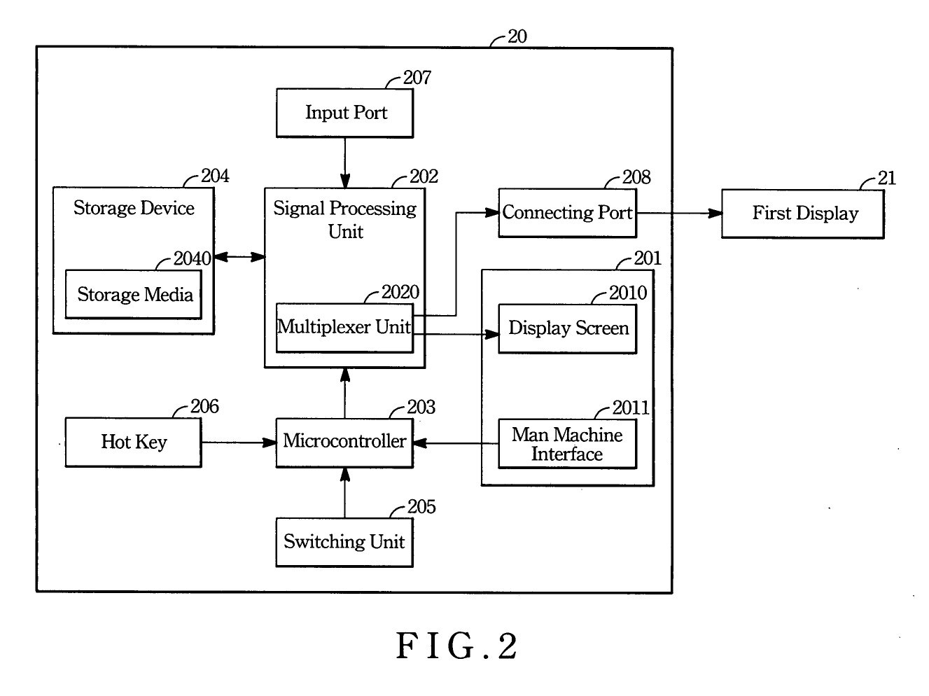

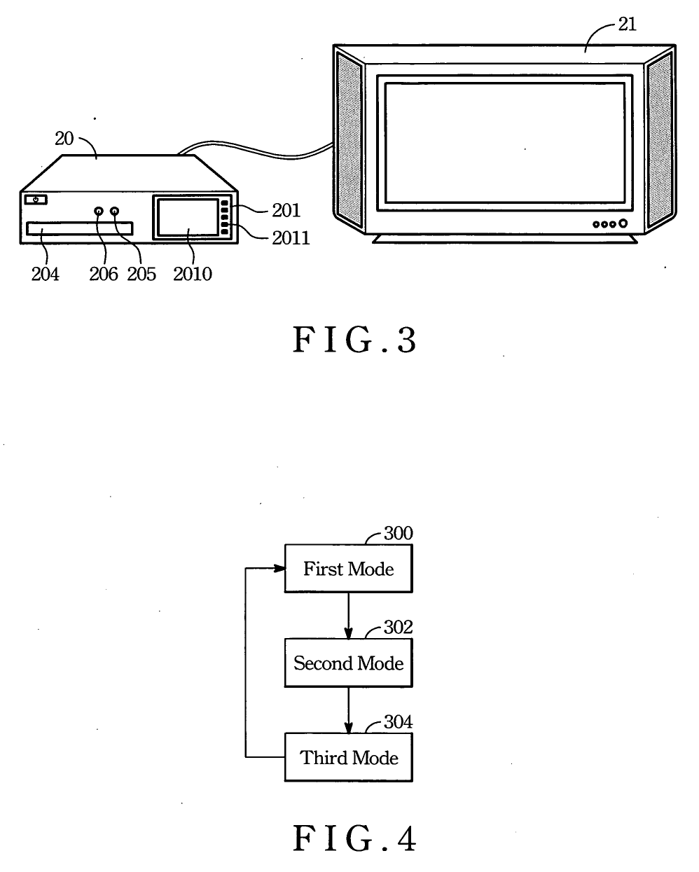

Firstly, please refer to FIG. 2 and FIG. 3, FIG. 2 is a system diagram of a video displaying device provided in accordance with a preferred embodiment of the present invention, and FIG. 3 is a front elevation of the video displaying device provided in accordance with the preferred embodiment of the present invention. As shown in FIG. 2, the video displaying device 20 is to connect to a first display 21. In the preferred embodiment of the present invention, the video displaying device 20 can be a DVD Recorder, a Video Set-up-Box, a DMA, etc. The first display 21 can be a television, a projector, a computer, etc. In FIG. 3, the video displaying device 20 is a DVD Recorder, and the first display is a television, but they are not to be limited to the scope of the present invention.

Please refer to FIG. 2, the video displaying device 20 includes a connecting port 208, a second display 201, a signal processing unit 202, a microcontroller 203 and a switching unit 205. The connecting port 208 is used for connecting to the first display 21, the signal processing unit 202 is used for generating a first video signal, the microcontroller 203 is used for generating a control signal and transmitting the control signal to the signal processing unit 202 to accordingly generate a second video signal, and the switching unit 205 is used for triggering the signal processing unit 202 to selectively transmit the first video signal and the second video signal to the connecting port 208 and the second display 201. According to FIG. 2, the signal processing unit 202 selectively outputs a the first video signal and the second video signal to the connecting port 208 and the second display 201 after the switching unit 205 triggers the microcontroller 203 and the microcontroller 203 triggers the signal processing unit 202.

The video displaying device 20 further includes an input port 207 and a storage media 2040 arranged within a storage device 204. The input port 207 is used for receiving external video data, the storage media 2040 is used for storing video data, and the first video signal and the second video signal are inputted from the input port 207 or the storage media 2040. The signal processing unit 202 can decode the external data received from the input port 207 and the video data stored in the storage media 2040, and transform them to a first video signal and a second video signal to accordingly display at least one video.

In the present invention, the input port 207 can be a wired transmission interface or a wireless transmission interface, where the wired transmission interface can be an RS232 transmission interface, a USB (Universal Serial Bus) transmission interface, a chromatic aberration terminal, an S terminal, an AV (Audio-Video) terminal, a coaxial cable terminal, an optical fiber terminal, etc. The wireless transmission interface can be an Infrared Data Association (IrDA) transmission interface, a Bluetooth transmission interface, an Ultra-wideband (UWB) transmission interface, a Wi-Fi transmission interface, etc. The storage media can be a CD (Compact Disk), a DVD (Digital Versatile Disk), a memory card, a mini hard disk, etc. The storage device 204 is applied for reading or executing the storage media 2040, e.g., the storage device can be a DVD writing and reading device, a card reader, etc. It is worthy to be mentioned that the signal transmission between the video displaying device 20 and the first display 21 can be by means of a wired transmission device or a wireless device, not limited in the field of the wired transmission device as provided in FIG. 3.

The signal processing unit 202 can selectively insert the control signal into the first video signal or the second video signal in order to display a plurality of control commands presented with OSD (On-Screen display), and the second display 201 includes a display screen 2010 and a man machine interface 2011. The display screen 2010 is used for displaying the control commands, and the man machine interface 2011 is corresponding to the control commands. In the present invention, the display screen can be an LCD (Liquid Crystal Display), an OLED (Organic Light Emitting Display), a plasma display, etc. The man machine interface 2011 can be a set of press buttons as shown in FIG. 3, a set of press buttons of a remote controller, or a touch screen connected to the display screen 2010.

When the first video signal is outputted via the connecting port 208, users can operate the man machine interface 2011 to set and save the external video data into the storage media 2040.

The video displaying device 20 further includes a multiplexer 2020 for inputting the first video signal and the second video signal, and the output end of the multiplexer 2020 connects to the connecting port 208 and the second display 201. The multiplexer 2020 can be provided by means of hardware, firmware or software in order to control the outputting statuses of the first video signal and second video signal, meanwhile, it is unnecessary to have more detail description of the multiplexer 2020 in the present invention due to the reason that many practices of the multiplexer 2020 are well known in prior art.

Please refer to FIG. 2, FIG. 3, and FIG. 4 simultaneously, FIG. 4 illustrates a mode switching sequence in accordance with the preferred embodiment of the present invention. The switching unit 205 can be a press button arranged on a panel of the video displaying device 20 or on a remote controller in order to control the multiplexer 2020 to selectively output in a first mode, a second mode, and a third mode. In the first mode, the multiplexer 2020 outputs the first video signal to the connecting port 208 and the second display 201; in the second mode, the multiplexer 2020 outputs the first video signal and the second video signal to the connecting port 208 and the second display 201 respectively; and in the third mode, the multiplexer 2020 outputs the first video signal and the second video signal to the second display 201 and the connecting port 208 respectively. As shown in FIG. 4, the multiplexer 2020 outputs signals in the first mode initially (step 300), the switching unit 205 is capable of changing the first mode to the second mode (step 302). Continuously, the second mode can be shifted to the third mode by means of the switching unit 204 (step 304), and then the multiplexer 2020 goes back to the first mode while triggering the switching unit 204 again (step 300).

The video displaying device 20 further includes a hot key 206 for triggering the microcontroller 203 outputting the control signal to the signal processing unit 202 to keep the first display 21 normally displaying the video according to the video signal, i.e., either the first video signal or the second video signal depending on the three different modes as mentioned, and also provided for interrupting displaying the video. So, it is able to select and execute control commands via the second display without interrupting the first display 21 displaying the video. Furthermore, the hot key 206 can be arranged on the panel of the video displaying device 20 as shown on FIG. 3, or arranged on the remote controller.

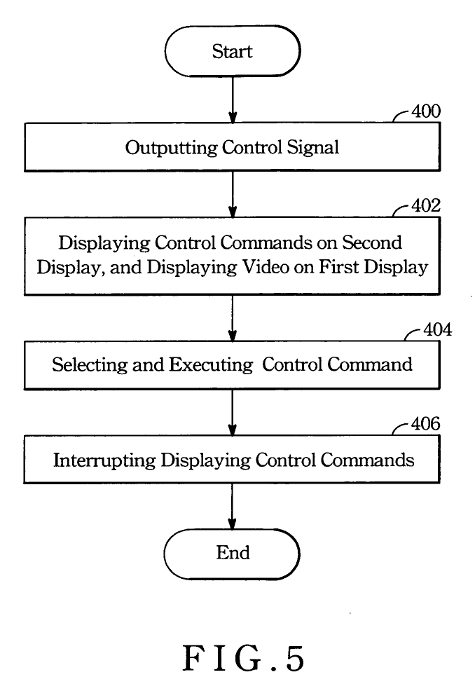

Please refer to FIG. 2 and FIG. 5, which is a flowchart presenting the steps of a method for setting the video displaying device as disclosed in the present invention. The method comprises the steps of outputting a control signal to the signal processing unit 202 by a user triggering the microcontroller 203 via the man machine interface 2011 (Step 400); receiving the control signal via the signal processing unit 202 and displaying a plurality of control commands being corresponded to the control signal, according to the control signal, on the second display 201 with OSD (On-Screen Display), and keeping the first display 21 normally outputting (Step 402); selecting and executing at least one of the control commands (Step 404); and interrupting displaying the control commands on the second display 201 (Step 406).

In step 400, the hot key 206 triggers the microcontroller 203 to output the control signal to the signal processing unit 202, therefore the signal processing unit 202 keeps that the first display 21 normally outputs the video signal. It is worth to be mentioned that the user cannot set the video displaying device under this status.

In the step 404, the control commands are always displayed on the second display 201 except for the user finishing to select and execute all control commands necessary to be set.

Moreover, the user also can switch the switching unit 205 to control the multiplexer 2020 to selectively output in the first mode, the second mode or the third mode when carrying out the steps as mentioned above, wherein the switching sequences are referred to FIG. 4. In the status, the first mode keeps displaying the video on the first display 21 and displaying the control commands on the second display 201; the second mode displays the control commands on the first display 21 and displays the video on the second display 201; and the third mode displays the video both on the first display 21 and the second display 201.

In step 406, the user presses the hot key 206 to trigger the second display 201 again to do more setting operations when the second display 201 stops displaying the control commands.

As a conclusion, the video displaying device 20 includes a second display 201 for displaying the video signals and the control commands, so that the user can do more setting operations even that the first display 21 has not been turned on yet, wherein the switching unit 205 is provided for switching the outputting modes to the first display 21 and the second display 201. Besides, the video displaying device 20 further provides with the hot key 206, so that the user can finish setting operations by selecting and executing control commands via the second display without interrupting the first display 21, and further upgrades the convenience of user's operations. Additionally, the user can realize all the working statuses of the video displaying device 20 by displaying them on the second display 201.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A video displaying device connected to a first display, the video displaying device comprising:
a connecting port for connecting to the first display;
a second display;
a signal processing unit for generating a first video signal;
a microcontroller for generating a control signal, which is transmitted to the signal processing unit for generating a second video signal; and
a switching unit for triggering the signal processing unit to selectively transmit the first video signal and the second video signal to the connecting port and the second display.

2. The video displaying device as claimed in claim 1, wherein the control signal corresponds to a plurality of control commands, the second display further comprising:
a display screen for displaying the plurality of control commands; and
a man machine interface being corresponding to the control commands.

3. The video displaying device as claimed in claim 2, the video displaying device further comprising:
an input port for receiving an external video data, the signal processing unit transforming the external video data to the first video signal; and
a storage media;
wherein when the connecting port outputs the first video signal, the man machine interface is used for setting and storing the external video signal in the storage media.

4. The video displaying device as claimed in claim 1, wherein the signal processing unit selectively inserts the control signal into the first video signal and the second video signal to make the control signal be presented with OSD (On-Screen Display).

5. The video displaying device as claimed in claim 1, the signal processing unit further comprising:
a multiplexer connecting the connecting port and the second display, and receiving the first video signal and the second video signal.

6. The video displaying device as claimed in claim 5, wherein the switching unit controls the multiplexer to selectively output in a first mode, a second mode and a third mode, in the first mode, the multiplexer outputting the first video signal to the connecting port and the second display, in the second mode, the multiplexer outputting the first video signal and the second video signal to the connecting port and the second display respectively, in the third mode, the multiplexer outputting the first video signal and the second video signal to the second display and the connecting port respectively.

7. The video displaying device as claimed in claim 6, wherein the first mode, the second mode, and the third mode is defined as the switching sequences of the switching unit controlling the multiplexer.

8. The video displaying device as claimed in claim 1, wherein the switching unit is a press button.

9. The video displaying device as claimed in claim 1, the video displaying device further comprising:
an input port for inputting a video data;
wherein the signal processing unit transforms the video signal to the first video signal.

10. The video displaying device as claimed in claim 9, wherein the input port is selected from the group of a wireless transmission interface and a wired transmission interface.

11. The video displaying device as claimed in claim 10, wherein the wireless transmission interface is selected from the group of an Infrared Data Association (IrDA) transmission interface, a Bluetooth transmission interface, an Ultra-wideband (UWB) transmission interface, and a Wi-Fi transmission interface.

12. The video displaying device as claimed in claim 10, wherein the wired transmission interface is selected from the group of an RS232 transmission interface, a USB (Universal Serial Bus) transmission interface, a chromatic aberration terminal, an S terminal, an AV (Audio-Video) terminal, a coaxial cable terminal, and an optical fiber terminal.

13. The video displaying device as claimed in claim 1, further comprising a storage media for storing video data, wherein the signal processing unit transforms the video data to the first video signal.

14. The video displaying device as claimed in claim 1, wherein the storage media is selected from the group of a CD (Compact Disk), a DVD (Digital Versatile Disk), a memory card, and a mini hard disk.

15. A method for setting a video displaying device, the video displaying device having a signal processing unit for selectively outputting at least one video signal to a first display and a second display, the method comprising:
(a) outputting a control signal to the signal processing unit;
(b) displaying a plurality of control commands corresponded to the control signal on the second display, and keeping the first display normally outputting; and
(c) selecting and executing at least one of the control commands.

16. The method as claimed in claim 15, further comprising:
interrupting displaying the control commands on the second display.

17. The method as claimed in claim 15, wherein the first display is externally connected to the video displaying device, the second display is embedded in the video displaying device, the video displaying device further comprises a connecting port for connecting to the first display.

18. The method as claimed in claim 15, wherein the signal processing unit inserts the control signal into the video signal to make the control commands overlap the video and be displayed with OSD (On-Screen Display).

19. The method as claimed in claim 15, wherein the video displaying device further comprises a microcontroller for generating the control signal.

20. The method as claimed in claim 19, wherein a hot key is provided for triggering the microcontroller to output the control signal to the signal processing unit, therefore the signal processing unit keeps the first display in normal output, and the hot key interrupts the normal output as well.
